(19) United States
(12) Patent Application Publication
(10) Pub. No.: US 2024/0425254 A1
(43) Pub. Date: Dec. 26, 2024

(54) PRINTED LAYERED BODY FOR PACKAGING

(71) Applicant: TOYO SEIKAN GROUP HOLDINGS, LTD., Tokyo (JP)

(72) Inventors: Atsushi Ebata, Yokohama-shi (JP); Toshiki Yamada, Yokohama-shi (JP); Kenya Majima, Yokohama-shi (JP)

(73) Assignee: TOYO SEIKAN GROUP HOLDINGS, LTD., Tokyo (JP)

(21) Appl. No.: 18/826,397

(22) Filed: Sep. 6, 2024

Related U.S. Application Data
(63) Continuation of application No. PCT/JP2023/005983, filed on Feb. 20, 2023.

(30) Foreign Application Priority Data
Mar. 10, 2022 (JP) 2022-037396
Mar. 10, 2022 (JP) 2022-037397

(51) Int. Cl. B65D 65/42; B65D 65/40

(52) U.S. Cl. CPC B65D 65/42; B65D 65/40

(57) ABSTRACT

A printed layered body for packaging has a basic layer structure including a barrier film, a printed layer, and an adhesive layer, and has a polyolefin content rate adjusted to 80 mass % or more. The barrier film includes a thermoplastic resin film and an inorganic coating formed on the surface of the film, and an adhesive layer has a storage elastic modulus exceeding 1.5 MPa at 120° C.

### CROSS-REFERENCE TO RELATED APPLICATIONS

This application is a Rule 53 (b) Continuation of International Application No. PCT/JP2023/005983 filed Feb. 20, 2023, which claims priority based on Japanese Patent Application Number 2022-037396 filed on Mar. 10, 2022 and Japanese Patent Application Number 2022-037397 filed on Mar. 10, 2022, the respective disclosures of which are incorporated herein by reference in their entirety

### TECHNICAL FIELD

The disclosure relates to a printed layered body for packaging, and more specifically to a printed layered body for packaging which has a printed layer that exhibits excellent oxygen barrier properties.

### BACKGROUND ART

Resin films represented by olefin resin films such as polypropylene films and polyethylene films have been widely used as packaging materials for many years because they have advantages that they are inexpensive and can be easily bonded by heat sealing to form a pouch.

Since such resin films have poor gas barrier properties, forming an inorganic coating on the surface of a resin film is known as a means for improving the gas barrier properties. Known examples of such an inorganic coating are a vapor-deposited film of aluminum oxide, silicon oxide, or the like, a coating mainly composed of silicon oxide, a coating formed by a crosslinking reaction between carboxylic acid and metal, a coating in which metal oxide is dispersed, and the like. Furthermore, providing the above-described coating on the above-described vapor-deposited film is known. A resin film having such an inorganic coating on the surface thereof exhibits high gas barrier properties and is therefore commercially available as a barrier film.

When a pouch is produced using the above-described barrier film, a heat-sealing resin layer is usually provided. Such a heat-sealing resin layer is bonded to the barrier film using an adhesive.

For example, Japanese Patent Application Laid-Open No. 2020-037187 discloses a layered body for packaging including a substrate film having the vapor-deposited film and the heat-sealing resin layer provided on the vapor-deposited film via an adhesive layer, wherein the adhesive layer is formed of a cured product of a two-part curable adhesive containing a polyester polyol, an isocyanate compound, and a phosphoric acid-modified compound.

Note that the adhesive layer is provided to connect layers formed of different materials, such as a substrate film and a heat-sealing resin, and the heat-sealing resin layer is provided to join the same kind of resin (heat-sealing resin), and is different from the adhesive layer.

However, a pouch obtained by bag making using this layered body for packaging ensures sufficient oxygen barrier properties unless retort sterilization is performed, but when retort sterilization is performed, the oxygen barrier properties are greatly decreased. Therefore, it is difficult to use such a layered body for packaging as a pouch for retort foods. The decrease in the oxygen barrier properties after the retort sterilization is considered to be caused by the expansion and contraction of the substrate film and the generation of cracks in the vapor-deposited layer due to heating during the retort sterilization. Such a decrease in oxygen barrier properties due to heating occurs not only when the vapor-deposited film is formed but also when other inorganic coatings are provided. Therefore, there is a need to ensure excellent oxygen barrier properties by the inorganic coating even after retort sterilization.

Japanese Patent No. 4117461 discloses a gas barrier polyolefin laminated film having a polyolefin film layer and a gas barrier layer. In this laminated film, the gas barrier layer is a film layer obtained by curing an epoxy resin containing an aromatic ring in the molecule with an epoxy resin curing agent, and exhibits excellent oxygen barrier properties. However, since the gas barrier layer does not have an inorganic coating such as a vapor-deposited film, oxygen barrier properties as high as those of a barrier film having an inorganic coating are not obtained regardless of the presence of retort sterilization.

Moreover, in PCT/JP2021/033240, the applicant has suggested a layered body for packaging, which exhibits excellent oxygen barrier properties even when heat treatment such as retort sterilization is performed. This layered body for packaging has a barrier film with an inorganic coating formed on the surface of a thermoplastic resin film and an adhesive layer provided on the inorganic coating, in which the adhesive layer is formed of an epoxy-based adhesive. That is, in the layered body for packaging, other layers such as a heat-sealing resin layer (sealant film) are laminated on the inorganic coating of the barrier film by the epoxy-based adhesive layer. Accordingly, the crack resistance of the inorganic coating is enhanced. Even when the layered body for packaging is subjected to bag production into a pouch by heat treatment such as retort sterilization, the decrease in the oxygen barrier properties due to heat treatment can be effectively avoided, and the characteristics of the barrier film (inorganic coating) can be sufficiently exhibited.

### SUMMARY

The inventors have further advanced the technique of the above-described prior application (PCT/JP2021/033240) and have found that when an adhesive layer used for laminating another layer on an inorganic coating of a barrier film has a high storage elastic modulus, the excellent oxygen barrier properties of the inorganic coating is ensured even when a printed layer is interposed between the inorganic coating and the adhesive layer, and the oxygen barrier properties are not impaired even when the polyolefin content rate in the layered body is high, thereby achieving the disclosure.

That is, an object of the disclosure is to provide a printed layered body for packaging which exhibits excellent oxygen barrier properties even when subjected to heat treatment such as retort sterilization, while the printed layered body for packaging has a printed layer, a high polyolefin content rate, and improved recycling adaptability.

According to the disclosure, there is provided a printed layered body for packaging, which has a basic layer structure including a barrier film, a printed layer, and an adhesive layer, in which a polyolefin content rate is adjusted to 80 mass % or more. The barrier film includes a thermoplastic resin film (A1) and an inorganic coating (A2) formed on the surface of the thermoplastic film, and the adhesive layer has a storage elastic modulus exceeding 1.5 MPa at 120° C.

In the printed layered body for packaging of the disclosure, the following aspects are suitably applied.

(1) the printed layer is provided between the inorganic coating (A2) and the adhesive layer;

(2) The printed layer is formed on the surface of the inorganic coating (A2).

(3) The printed layer contains titanium oxide.

(4) The inner surface side film including a heat-sealing resin layer is laminated via the adhesive layer.

(5) The adhesive layer is formed of an epoxy-based adhesive.

(6) The inorganic coating (A2) is formed from a vapor-deposited layer deposited using the thermoplastic resin film (A1) as a base.

(7) The vapor-deposited layer is formed of silicon oxide, aluminum oxide, or silica-alumina composite oxide.

(8) An inorganic coating layer is provided as a protective layer on the vapor-deposited layer.

(9) The inorganic coating layer is formed of metal alkoxide or a condensate thereof.

(10) The heat-sealing resin layer is formed from an olefin-based resin composition.

(11) The olefin-based resin composition is formed from polypropylene, linear low-density polyethylene, or a mixture of both.

(12) The olefin-based resin composition contains an impact polypropylene component (a), in which ethylene-propylene copolymer is dispersed in polypropylene, and linear low-density polyethylene (B), and the mass ratio of both components (a/B) is in the range of from 99/1 to 50/50.

(13) The thermoplastic resin film (A1) is a drawn polypropylene film.

According to the disclosure, there is further provided a pouch obtained by bonding the above-described printed layered bodies for packaging by heat sealing.

The printed layered body for packaging of the disclosure usually has a basic structure, in which a printed layer (printed ink image) is provided between a barrier film having an inorganic coating film (A2) and an adhesive layer, and another layer (e.g., a layer having a heat-sealing resin layer) is further laminated on the adhesive layer, and generally has the following two features.

(i) The adhesive layer has a storage elastic modulus greater than 1.5 MPa at 120° C.

(ii) The polyolefin content rate in the entire printed layered body for packaging including the layer laminated by the adhesive layer is 80 mass % or more.

That is, explaining the feature (i), as described later in the example, the storage elastic modulus is a parameter measured by a dynamic viscoelasticity test (10 Hz) at 120° C. The fact that the storage elastic modulus at 120° C. indicates a high value as described above means that the adhesive layer suppresses the expansion and contraction of the substrate film and the inorganic coating (A2) during heat treatment such as retort sterilization, which is performed around 120° C. As a result, when this printed layered body for packaging is used to form a pouch by bag production and subjected to heat treatment such as retort sterilization, cracking of the inorganic coating (A2) and film peeling are effectively prevented, and excellent oxygen barrier properties are exhibited. It is a great advantage of the disclosure that such properties of the adhesive layer are exhibited even when a printed layer (i.e., a layer containing printing ink) is interposed between the adhesive layer and the inorganic coating (A2).

Moreover, explaining the feature (ii), the printed layered body for packaging of the disclosure, which has an adhesive layer exhibiting a high storage elastic modulus value at 120° C., exhibits high oxygen barrier properties even when subjected to heat treatment (the feature (i)). Such oxygen barrier properties are exhibited even when the polyolefin is contained in a proportion of 80 mass % or more. That is, polyolefin has lower oxygen barrier properties than a gas barrier resin represented by an ethylene-vinyl alcohol resin or aromatic polyamide. However, in the disclosure, since the layered structure is formed on the inorganic coating (A2) of the barrier film by using the aforementioned adhesive layer, excellent oxygen barrier properties can be secured even by using almost only polyolefin without using gas barrier resins. This means that the printed layered body for packaging of the disclosure also has a great advantage of improving the recyclability of the pouch.

The printed layered body for packaging of the disclosure exhibits excellent oxygen barrier properties not only before retorting but also after retorting, and thus is suitably used as a pouch for retort foods.

### DESCRIPTION OF EMBODIMENTS

### Basic Layer Structure of Printed Layered Body for Packaging

In the disclosure, an inorganic coating (A2) is deposited using a thermoplastic resin film (A1) as a base, and usually, the thermoplastic resin film (A1), in which the inorganic coating (A2) is formed on the surface thereof, is integrally handled as a barrier film.

The printed layered body for packaging of the disclosure having such a barrier film has a basic layer structure (1) or (2) presented below.

### Basic Structure (1):

barrier film/printed layer/adhesive layer/inner surface side film

### Basic Structure (2):

reinforcing film/printed layer/adhesive layer/barrier film/adhesive layer/inner surface side film

In this basic structure, an adhesive layer is provided on both sides of the barrier film.

In the basic layer structure (1), as understood from the position of the printed layer, the thermoplastic resin film is the outer surface. Therefore, the basic layer structure (1) can also be represented as follows.

### Barrier Film (Inorganic Coating)/Printed Layer/Adhesive Layer/Inner Surface Side Film

In addition, since the printed layer must be visually recognized from outside, it is necessary that the outer surface side of the printed layer has transparency to such an extent that the printed layer can be visually recognized. For example, the materials of the thermoplastic resin film and the inorganic coating, and further the reinforcing film are set so that the haze is about 5% or less.

Moreover, in the basic layer structure (2), the adhesive layer is provided on both sides of the barrier film, and in this aspect, the reinforcing film is positioned on the outermost surface. It is usually a drawn olefin-based oriented film.

Furthermore, in the above-described basic layer structures (1) and (2), the inner surface side film faces the substance to be packaged, and may be a single layer film or a multilayer film. When the inner surface side film is used for bag production into a pouch, the innermost surface of the inner surface side film is a heat-sealing resin layer (sometimes called a sealant).

### Barrier Film

### Thermoplastic Resin Film (A1);

In the barrier film, the thermoplastic resin film serves as a base of the inorganic coating and is produced by a known means such as extrusion or co-extrusion molding.

Such thermoplastic resins are not limited in principle, and various thermoplastic resins can be used including olefin-based resins including, for example, polyolefins such as low-density polyethylene, high-density polyethylene, medium density polyethylene, polypropylene, poly(1-butene); poly(4-methyl-1-pentene), or random or block copolymers of α-olefins such as ethylene, propylene, 1-butene, and 4-methyl-1-pentene, and cyclic olefin copolymers.

Since the printed layered body for packaging of the disclosure contains polyolefin of at least 80 mass % or more, preferably 90 mass % or more in order to enhance the recyclability of the pouch, the following resins can be also used for forming the thermoplastic resin film in addition to the above-described olefin resins as long as such a high polyolefin content rate is maintained.

Ethylene-vinyl compound copolymers such as ethylene-vinyl acetate copolymers, ethylene-vinyl alcohol copolymers, and ethylene-vinyl chloride copolymers;
styrene-based resins such as polystyrene, acrylonitrile-styrene copolymers, ABS, and α-methylstyrene-styrene copolymers;
polyvinyl-based resins such as polyvinyl chloride, polyvinylidene chloride, vinyl chloride-vinylidene chloride copolymers, polymethyl acrylate, and polymethyl methacrylate;
polyamides such as nylon 6, nylon 6-6, nylon 6-10, nylon 11, and nylon 12;
thermoplastic polyesters such as polyethylene terephthalate (PET), polybutylene terephthalate, and polyethylene naphthalate (PEN);

other resins such as polycarbonates polyphenylene oxides, polyimide resins, polyamide-imide resins, polyetherimide resins, fluororesins, allyl resins, polyurethane resins, cellulose resins, polysulfone resins, polyethersulfone resins, ketone resins, amino resins, polylactic acid, and the like may be used.

In addition, blends of the resins exemplified above and those resins modified by copolymerization as appropriate (e.g., acid-modified olefin resins, and the like) are also acceptable.

Moreover, it may also be a multilayer film in which a layer of an olefin-based resin and a layer of a resin other than an olefin-based resin are appropriately laminated by a known adhesive resin such as an acid-modified olefin resin.

In the printed layered body for packaging of the disclosure, the thermoplastic resin film is preferably an olefin-based resin film from the viewpoint of being used for forming retort pouches having high recyclability, and is more preferably polypropylene from the viewpoint of strength as pouches in particular, and the like.

In addition, the thermoplastic resin film is preferably drawn in one or two axial directions from the viewpoint of having sufficient heat resistance to withstand retort sterilization. The stretching ratio may be such that film breakage due to overstretching does not occur, and is usually 2 times or more.

The thermoplastic resin film described above only needs to have an appropriate thickness according to the capacity of the pouch to be finally manufactured or the like. If the thermoplastic film is excessively thin, the strength may be reduced due to loss of orientation or the like when depositing the inorganic coating described later. Therefore, the thermoplastic resin film preferably has a thickness of at least 10 μm or more.

### Inorganic Coating (A2);

The inorganic coating provided on the surface of thermoplastic resin film described above is provided to ensure oxygen barrier properties. Examples thereof include vapor-deposited films of various metals or metal oxides, coating films mainly composed of silicon oxide compounds, coating films formed by crosslinking reaction between carboxylic acids and metals, and coating films in which metal oxides are dispersed. On the vapor-deposited film, a coating film as described above is suitably provided as a protective film (so-called topcoat layer).

The vapor-deposited film is an inorganic vapor-deposited film formed by a technique such as physical vapor deposition typified by sputtering, vacuum vapor deposition, ion plating, or the like, or chemical vapor deposition typified by plasma CVD, and is, for example, a film formed of some metal or metal oxide. Since such a vapor-deposited film is formed of an inorganic substance, it exhibits higher oxygen barrier properties against a gas barrier resin such as an ethylene-vinyl alcohol copolymer.

Although the vapor-deposited film may be formed directly on the surface of the above-mentioned thermoplastic resin film, it is preferable to coat the surface of the thermoplastic resin film with a hydrophilic resin such as polyester, polyethyleneimine, an acrylic resin, polyamide, or polyurethane and form the vapor-deposited film on the coating film (so-called anchor coat layer) in order to enhance the smoothness of the vapor-deposited film and the adhesion to the surface of the thermoplastic resin film.

In the disclosure, the inorganic coating is preferably formed of a vapor-deposited film formed of silicon oxide, aluminum oxide, silica-alumina composite oxide or the like from the viewpoint that the formed film is dense and ensures particularly high oxygen barrier properties, and is most suitably a vapor-deposited film of silicon oxide because the vapor-deposited film particularly ensures transparency (the haze is 5% or less) and exhibits good visibility to the printed layer described later.

In addition, it is preferable that the above-mentioned coating film of an inorganic substance be provided as a protective film (topcoat layer) on the vapor-deposited film. Such a coating film penetrates into fine defects (cracks) generated in the above-mentioned vapor-deposited film, and functions as a protective film for preventing growth of defects and preventing generation of new defects. The coating film suitably contains a metal alkoxide such as alkoxysilane or alkoxytitanium, and is suitably partially condensed from the viewpoint of adhesion to the vapor-deposited film.

The thickness of the inorganic coating described above varies depending on the required level of oxygen barrier properties, and in the case of a vapor-deposited film, the inorganic coating is required to be thick enough to ensure an oxygen permeability of 1 cc/m²/day/atom or less before retort treatment without impairing the properties of the underlying thermoplastic resin film upon vapor deposition, and the thickness is generally required to be from about 1000 to 10 nm, particularly from about 100 to 10 nm.

The thickness and constituent elements of the inorganic coating. They can be determined by depth direction analysis using X-ray photoelectron spectroscopy (XPS) or Auger electron spectroscopy (AES), energy dispersive X-ray analysis (EDX), or the like.

### Printed Layer

In the disclosure, a printed layer is formed on the above-described inorganic coating (or the reinforcing film).

Such a printed layer itself is formed on the surface of the inorganic coating by a known printing method such as ink jet printing, screen printing or gravure printing, and is formed by each color ink, which includes a solution in which a dye or a pigment is dispersed in a resin serving as a binder, in the form of a line, a character, a pattern, or the like, and appropriately heating and drying the ink.

Typical examples of the ink resin (binder) used for the printing ink include polyurethane resins, polyurethaneurea resins, acrylic-modified urethane resins, acrylic-modified urethaneurea resins, vinyl chloride-vinyl acetate copolymer-based resins, rosin-based resins (e.g., rosin-modified maleic acid resins), polyamide-based resins, polyester-based resins, chlorinated polypropylene resins, acryl-based resins, nitrocellulose-based resins, rubber-based resins, and the like. In particular, urethane-based resins, vinyl chloride-vinyl acetate copolymer-based resins, and polyester-based resins are preferable from the viewpoint of bondability to the adhesive layer described later.

Moreover, the printed layer may be a solid layer or a local layer including an image or a linear pattern formed by ink of each color. In addition, the printed layer may be a solid layer in which a gradation-like pattern is formed by each color ink, or may be formed of a plurality of layers in which each color ink is superimposed. Further, when an ink image of a color other than white is formed in the printed layer, a white printed layer formed from a white ink containing titanium oxide is preferably formed as a background so as to cover such an ink image. As a result, the visibility of the ink image is significantly improved.

The total thickness of the above-described printed layer is 5 μm or less, which is extremely thin. Therefore, the printed layer hardly affects the adhesion exhibited by the adhesive layer described later.

### Adhesive Layer

In any pattern of the basic layer structure (1) and the basic layer structure (2), the above-described adhesive layer is formed on the inorganic coating directly or with the printed layer interposed therebetween. Such an adhesive layer is a layer having a storage elastic modulus exceeding 1.5 MPa at 120° C. That is, since the adhesive layer exhibits a large storage elastic modulus at 120° C., the expansion and the contraction of the substrate film and the inorganic coating are suppressed when heat treatment such as retort sterilization is performed from around 100 to 120° C. As a result, the generation of defects such as cracks in the inorganic coating and peeling are effectively suppressed, thereby effectively avoiding a decrease in the oxygen barrier properties.

In the disclosure, in order to form an adhesive layer exhibiting a large storage elastic modulus as described above, an epoxy-based adhesive known as a dry laminate adhesive is used.

### Epoxy-Based Adhesive;

The above-described epoxy-based adhesive adheres by curing a liquid epoxy resin with an epoxy curing agent.

The epoxy resin is a liquid resin having an epoxy group in the molecule, and typical examples thereof include those obtained by reaction of epichlorohydrin with a phenol compound, an amine compound, a carboxylic acid or the like, and those obtained by oxidation of an unsaturated compound such as butadiene with an organic peroxide or the like, and any type of epoxy resin can be used.

Specific examples of the epoxy-based adhesive include, but are not limited to, bisphenol A type or bisphenol F type epoxy resins, novolac type epoxy resins, cyclic aliphatic type epoxy resins, long chain aliphatic type epoxy resins, glycidyl ester type epoxy resins, glycidyl amine type epoxy resins, and the like.

In the disclosure, a glycidylamine type epoxy resin is particularly preferable in that an adhesive layer having a high elastic modulus can be formed.

Furthermore, as the epoxy curing agent, a known epoxy curing agent such as an amine-based curing agent, an acid anhydride, or a polyamide can be used. In particular, from the viewpoint of forming a coating (adhesive layer) having a high elastic modulus and easily following thermal shrinkage, an amine-based curing agent, particularly an aromatic polyamine typified by metaphenylene diamine is suitably used.

The amount ratio between the epoxy resin and the curing agent may be set so that a sufficient cured film is formed according to the epoxy equivalent of the epoxy resin.

In the disclosure, the epoxy-based adhesive described above is applied onto the inner surface side film described later using volatile organic solvents such as hydrocarbons, alcohols, ketones, esters, and ethers, and dried to form the adhesive layer.

That is, the printed layered body for packaging of the disclosure is obtained by laminating the adhesive layer formed on the surface of the inner surface side film on the inorganic coating on which the above-mentioned printed ink image (and further the white printed layer) is formed. The adhesive layer thus formed is typically cured by keeping at a temperature of from about 30 to 50° C. for 24 hours or more.

### Reinforcing Film

The reinforcing film used in the pattern of the basic layer structure (2) is an olefin-based drawn film which is also used as a base of the inorganic coating in the above-mentioned barrier film, and the use of such a film improves heat resistance and mechanical strength. As a matter of course, in addition to the olefin-based drawn film, a polyamide drawn film or the like can also be used as the reinforcing film. In the disclosure, a polyolefin, particularly a polypropylene drawn film is usually used as the reinforcing film because of the limitation that the polyolefin content rate is maintained at 80 mass % or more.

### Inner Surface Side Film

The inner surface side film having the above-mentioned adhesive layer on the surface thereof may have a single layer structure or a multilayer structure having a plurality of layers, but at least the surface opposite to the adhesive layer must be a heat-sealing resin layer (hereinafter sometimes referred to as a sealant). That is, since this sealant is easily melted by heating and is immediately solidified by cooling, the layered body can be thermally adhered to various objects by using this characteristic, and a pouch can be produced by thermally adhering (heat-sealing) such layered bodies to each other.

In the disclosure, films made of various thermoplastic resins can be used as the film used for forming the sealant. In the disclosure, it is necessary to set the polyolefin content rate to 80 mass % or more in order to improve the recyclability of the pouch. For this reason, as the sealant film, a film made of an olefin resin such as homopolypropylene (homo PP), random polypropylene (random PP), impact polypropylene (impact PP), or linear low-density polyethylene (LLDPE) is referred to. However, since it is necessary to ensure heat resistance and impact resistance for use in the production of pouches to be subjected to retort treatment, a CPP film (non-drawn polypropylene film, also called a cast PP film) is suitably used. In particular, a CPP film made of impact PP is most suitably used because excellent impact resistance and heat resistance can be ensured.

The CPP film using the above-described impact PP is molded by melt extrusion of a propylene-based resin composition, and this propylene-based resin composition may contain a linear low-density polyethylene (B) in addition to an impact PP component (a).

### Impact PP Component (α);

The impact PP component is formed of impact polypropylene (impact PP), and the impact PP component used in the disclosure has a structure in which an ethylene-propylene copolymer (EPR) is dispersed especially in a homo or random polypropylene. That is, the dispersion of the EPR in the polypropylene imparts impact resistance to the polypropylene. A known rubber component dispersed in the polypropylene includes, in addition to EPR, a styrene-butadiene copolymer (SBR), and an ethylene-propylene-butene copolymer (EPBR). Although components other than EPR can improve the impact resistance, EPR is most suitable in that it can also improve the impact resistance at low temperatures.

The impact PP component as described above has a melt flow rate (MFR, 230° C.) in a range approximately of from 0.5 to 10 g/10 min from the viewpoint of film moldability (extrusion moldability) or the like.

Moreover, the EPR content rate in the impact PP component can be represented by a xylene soluble fraction percentage when the CPP film used for forming the heat-sealing resin layer is dissolved in boiling xylene, and the xylene-soluble fraction percentage is desired to be 8 mass % or more, particularly in the range of from 8 to 20 mass %. That is, when the xylene-soluble fraction percentage is smaller than the above range, the impact resistance of the pouch is lowered because the amount of EPR is small. On the other hand, when the soluble fraction is excessively high, the appearance of the pouch may be poor.

### Linear Low-Density Polyethylene (β);

This linear low-density polyethylene (LLDPE) is a component that functions as a compatibilizer between the polypropylene (PP) and the ethylene-propylene copolymer (EPR) when mixed with the impact PP described above and greatly improves dispersion of EPR in PP, thereby allowing EPR to sufficiently exhibit its impact improving effect.

This impact polypropylene component (α) and the LLDPE (β) are used such that the mass ratio (α/β) of both components is in the range of from 99/1 to 50/50.

Such LLDPE has a density in the range of from 0.860 to 0.925 g/cm 3, and is obtained by copolymerizing ethylene with an α-olefin such as butene-1, hexene-1,4-methylpentene-1 or octene-1. The LLDPE is obtained by introducing a short-chain α-olefin chain as a branch into a long-chain ethylene chain to reduce the density, and has extremely high molecular linearity.

In addition, since this LLDPE is mixed with the impact PP to be used, in order to not impair film formability, the LLDPE having an MFR (190° C.) of from 1.0 to 15 g/10 min is suitably used. As comonomer components, hexene-1 and 4-methylpentene-1 (methylpentene) are preferable, and methylpentene is most preferable.

Moreover, this LLDPE preferably contains comonomer α-olefin content rate of 10 mol % or less and has a number average molecular weight of 10000 or more measured by GPC calibrated with polystyrene. That is, when the comonomer α-olefin content rate is large or when the number average molecular weight is small and the low molecular weight component is contained in a large amount, the oil resistance and the flavor property to the contents are deteriorated when used as a pouch.

For the LLDPE described above, the composition of the film is preferably designed so that the amount of LLDPE in the CPP film (corresponding to the amount of LLDPE in the heat-sealing resin layer) is 20 mass % or less. That is, if the content of LLDPE is excessive, the blocking resistance and heat resistance of the film may be impaired.

Note that, in the propylene-based resin composition used for forming the CPP film, a known additive may be blended in an amount within a range that does not impair recyclability.

The CPP film including the impact PP component described above is produced by dry-blending components and feeding them to an extruder to melt-knead them, melt-extruding the blend into a film shape from a T-die, and bringing the extruded film-shaped melt into contact with a cooling roll to solidify the melt and a solidified film is wound.

The thickness of such a CPP film is not particularly limited, and is usually preferably in the range of from 20 to 100 μm, and particularly preferably in the range of from 50 to 80 μm in consideration of rigidity, unsealing property, and the like.

In the disclosure, the sealant film may have a multilayer structure in which another resin layer is laminated on the sealant film, and a resin other than the olefin-based resin or an adhesive can be used for such another resin layer as long as the olefin content rate is 80 mass % or more (particularly 90 mass % or more) based on the entire layered body.

Typical examples of such other resins include polyamide-based resins and ethylene-vinyl alcohol copolymers. These resins are particularly effective for further enhancing the oxygen barrier properties and are also suitable for enhancing the puncture strength of the film.

Moreover, the adhesive appropriately used for forming the multilayer structure of the inner surface side film is not particularly limited, but the epoxy-based adhesive used for forming the aforementioned adhesive layer above is preferably used.

In the disclosure, to form the inner surface side film with a multilayer structure, a drawn film of polypropylene is preferable in order to maintain the high polyolefin content rate. This film is also used as a base film of the inorganic coating for the aforementioned reinforcing film and the barrier film.

The adhesive used for introducing such a drawn film of polypropylene into the inner surface side film is also preferably the epoxy-based adhesive used for forming the adhesive layer mentioned above.

### Usage Mode of Printed Layered Body for Packaging

The above-described printed layered body for packaging of the disclosure is suitably used as a pouch (bag-like container) after being made into a bag by bonding by heat sealing with the heat-sealing resin layer.

Bag production is carried out by known means. For example, an empty pouch is produced by three-side sealing using two layered bodies, contents are filled from the opening portion, and finally the opening portion is closed by heat sealing.

In addition, it is also possible to produce an empty pouch by folding back a single layered body and heat-sealing both side edges. In this case, it is not necessary to heat seal the bottom portion. Furthermore, it is also possible to produce empty pouches using layered bodies only for side portions or bottom portions. Such a method is advantageous in increasing the volume of the pouch or providing a standing property.

The pouch thus produced by bag production from the printed layered body for packaging of the disclosure and filled with contents has excellent oxygen barrier properties and is also excellent in heat resistance and impact resistance. Moreover, even when the pouch is subjected to sterilization treatment (retort treatment) with heated steam at from 100 to 130° C., a decrease in oxygen barrier properties is effectively avoided, and excellent oxygen barrier properties are maintained. Such pouches are therefore particularly well suited for containing foodstuffs.

In addition, in the above-described pouch, from the viewpoint of recyclability, the types of various materials, the thicknesses of various layers, and the like are adjusted so that the olefin-based resin content rate is 80 mass % or more.

### EXAMPLE

The excellent effects according to an embodiment of the disclosure will be described in the following examples.

The following materials were used in the experiments below.

### Barrier Film

Two transparent vapor-deposited drawn polypropylene films including the following vapor-deposited films were used.

### Barrier Film A:

Vapor-deposited film: silicon oxide (SiOx)

Thickness: 20 μm

### Barrier Film B:

Vapor-deposited film: aluminum oxide (AlOx)

Thickness: 20 μm

### Reinforcing Film

### Drawn Polypropylene Film

Thickness: 20 μm

### Inner Surface Side Film

The following three types of sealant films were used.

Non-drawn polypropylene film a (PP(a))

### Polypropylene Species:

Mixture of impact PP and linear low-density polyethylene (LLDPE)

Mass Ratio (impact PP:LLDPE)=80:20

Thickness: 70 μm

Non-drawn polypropylene film b (PP(b))

Polypropylene species: random PP

Thickness: 70 μm

Non-drawn polyethylene film c (PE (c))

Polyethylene species: LLDPE

Thickness: 80 μm

### Adhesive

### Epoxy-Based Adhesive

Coating liquid: polyepoxy resin/polyamine resin/mixed solvent=5.4/18.6/60 (mass ratio)

(Mixed solvent mass ratio: methanol/ethyl acetate=9/1)

### Urethane-Based Adhesive

Coating liquid: polyol resin/polyisocyanate resin/ethyl acetate=40/5/60 (mass ratio)

### Printed Layer

Ink/mixed solvent=1/1 (mass ratio)

Ink: contained from 20 to 30 mass % of titanium oxide

Solvent: propyl acetate/isopropyl alcohol/methyl ethyl

Ketone/propylene glycol monomethyl ether=60/20/15/5 (mass ratio)

### Forming Printed Layer

The printed layer was applied to one side of the film positioned at the outermost layer by using a bar coater.

In the case of the barrier film, the printed layer was applied to the vapor-deposited surface side. In the case of the reinforcing film, the printed layer was applied to the corona-treated side.

### Forming Layered Body

The adhesive coating liquid was applied to the film by using a bar coater. The coating amount of the adhesive liquid was about 3 g/m² based on solids.

A layered body was prepared by laminating in the following layer constitution by a dry lamination method and curing at 50° C. for four days.

Outermost layer/printed layer/adhesive layer/intermediate layer/adhesive layer/sealant layer

### Calculation of Polyolefin Content Rate in Layered Body

Polyolefin Content Rate (mass %) in Layered Body=mass of polyolefin/mass of layered body

Herein, the mass of the layered body is the sum of the mass of polyolefin (the total mass of the outermost layer, the intermediate layer, and the sealant layer) and the total mass of the printing ink and the adhesive.

However, since the inorganic coating of the barrier film is very thin and has almost no mass, it is not taken into consideration.

### Bag Making

The layered body was cut into two pieces having a size of 140 mm×180 mm.

Further, three sides other than the opening (filling portion) were sealed with an impulse sealer available from Fuji Impulse Co., Ltd. Then the filling portion was filled with water of 200 g, and finally the filling portion was sealed to produce a pouch.

Sealing conditions: 195° C., 1.4 sec

Seal width: 5 mm

### Retort

The pouch was subjected to retort treatment in a shower at 121° C. for 30 minutes.

### Measurement of Elastic Modulus of Adhesive Layer

Preparing Adhesive Coating Film (Adhesive Layer)

Adhesive coating liquids were prepared and applied to a silicon plate to prepare an adhesive coating film.

Measurement of Elastic Modulus;

A dynamic viscoelasticity measuring device available from Seiko Instruments Inc. was used.

Test specimen film: length of 5.0 mm and width of 10 mm

Temperature range: from 20° C. to 150° C.

Temperature increase rate: 3° C./min

Frequency: 10 Hz

The storage elastic modulus E′ at 120° C. was evaluated.

### Measurement of Oxygen Transmission Rate

### Sample Preparation:

A film was cut out from the pouch subjected to retort treatment to prepare a measurement sample.

### Measurement of Oxygen Transmission Rate

OX-TRAN2/22 available from MOCON, Inc. was used.

Measurement conditions: 23° C., 60% RH

### Example 1

The coating film elastic modulus of the epoxy-based adhesive was measured.

Next, a layered body having the following layer configuration was prepared by a dry lamination method using a coating liquid of an epoxy-based adhesive.

barrier film A/printed layer/adhesive/reinforcing film/adhesive/PP (a)

(Polyolefin content rate: 91 mass %)

The above-described layered body was produced into a bag. Then, a retort treatment was performed. A film was cut out to measure the oxygen transmission rate. Table 1 indicates the evaluation results.

### Example 2

The same operation as in Example 1 was carried out except that PP (a) was replaced by PP (b). Table 1 indicates the evaluation results.

### Example 3

The same operation as in Example 1 was carried out except that PP (a) was replaced by PE (c). Table 1 indicates the evaluation results.

### Example 4

The same operation as in Example 1 was carried out except that the barrier film A was replaced by the barrier film B. Table 1 indicates the evaluation results.

### Example 5

A layered body with the following layer configuration was produced by a dry lamination method using a coating liquid of an epoxy-based adhesive.

reinforcing film/printed layer/adhesive/barrier film A/adhesive/PP (a)

(Polyolefin content rate: 91 mass %)

Note that the lamination was performed so that the vapor-deposited surface of the barrier film A faced the outermost layer.

The above-described layered body was produced into a bag. Then, a retort treatment was performed. A film was cut out to measure the oxygen transmission rate. Table 1 indicates the evaluation results.

### Example 6

The same operation as in Example 5 was carried out except that PP (a) was replaced by PE (c). Table 1 indicates the evaluation results.

### Example 7

The same operation as in Example 5 was carried out except that the barrier film A was replaced by the barrier film B and PP (a) was replaced by PE (c). Table 1 indicates the evaluation results.

### Example 8

The same operation as in Example 5 was carried out except that bonding was performed so that the vapor-deposited surface side of the barrier film A faced the sealant layer. In this case, the barrier film A is denoted as a “barrier film 1A.” Table 1 indicates the evaluation results.

### Comparative Example 1

The coating film elastic modulus of the urethane-based adhesive was measured.

Next, a layered body with the following layer configuration was produced by a dry lamination method using a coating liquid of a urethane-based adhesive.

barrier film A/printed layer/adhesive/reinforcing film/adhesive/PP (a)

(Polyolefin content rate: 91 mass %)

The above-described layered body was produced into a bag. Then, a retort treatment was performed. A film was cut out to measure the oxygen transmission rate. Table 2 indicates the evaluation results.

### Comparative Example 2

The same operation as in Comparative Example 1 was carried out except that PP (a) was replaced by PP (b). Table 2 indicates the evaluation results.

### Comparative Example 3

The same operation as in Comparative Example 1 was carried out except that PP (a) was replaced by PE (c). Table 2 indicates the evaluation results.

### Comparative Example 4

The same operation as in Comparative Example 1 was carried out except that the barrier film A was replaced by the barrier film B. Table 2 indicates the evaluation results.

### Comparative Example 5

A layered body with the following layer configuration was produced by a dry lamination method using a coating liquid of a urethane-based adhesive.

reinforcing film/printed layer/adhesive/barrier film A/adhesive/PP (a)

(Polyolefin content rate: 91 mass %)

Note that the lamination was performed so that the vapor-deposited surface of the barrier film A faced the outermost layer.

The above-described layered body was produced into a bag. Then, a retort treatment was performed. A film was cut out to measure the oxygen transmission rate. Table 2 indicates the evaluation results.

### Comparative Example 6

The same operation as in Comparative Example 5 was carried out except that PP (a) was replaced by PE (c). Table 2 indicates the evaluation results.

### Comparative Example 7

The same operation as in Comparative Example 5 was carried out except that the barrier film A was replaced by the barrier film B and PP (a) was replaced by PE (c). Table 2 indicates the evaluation results.

### Comparative Example 8

The same operation as in Comparative Example 5 was carried out except that bonding was performed so that the vapor-deposited surface side of the barrier film A faced the sealant layer. In this case, the barrier film A is denoted as a “barrier film 1A.” Table 2 indicates the evaluation results.

TABLE 1

| | | | | | Polyolefin | Oxygen | Storage Elastic |
|---|---|---|---|---|---|---|---|
| | Layer Configuration | | | | Content Rate in | Transmission | Modulus of |
| | Outermost | Intermediate | Sealant | | Layered Body | Rate | Adhesive |
| | Layer | Layer | Layer | Adhesive | (mass %) | (cc/m²/day/atm) | (MPa) |
| Example | Barrier Film | Reinforcing | PP(a) | Epoxy- | 91 | 1.5 | 39 |
| 1 | A | Film | | Based | | | |
| Example | Barrier Film | Reinforcing | PP(b) | Epoxy- | 91 | 2.2 | 39 |
| 2 | A | Film | | Based | | | |
| Example | Barrier Film | Reinforcing | PE(c) | Epoxy- | 92 | 3.4 | 39 |
| 3 | A | Film | | Based | | | |
| Example | Barrier Film | Reinforcing | PP(a) | Epoxy- | 91 | 0.82 | 39 |
| 4 | B | Film | | Based | | | |
| Example | Reinforcing | Barrier Film | PP(a) | Epoxy- | 91 | 2.4 | 39 |
| 5 | Film | A | | Based | | | |
| Example | Reinforcing | Barrier Film | PE(c) | Epoxy- | 92 | 4.2 | 39 |
| 6 | Film | A | | Based | | | |
| Example | Reinforcing | Barrier Film | PE(c) | Epoxy- | 92 | 0.50 | 39 |
| 7 | Film | B | | Based | | | |
| Example | Reinforcing | Barrier Film | PP(a) | Epoxy- | 91 | 1.9 | 39 |
| 8 | Film | 1A | | Based | | | |

TABLE 2

| | | | | | | | Storage |
|---|---|---|---|---|---|---|---|
| | | | | | Polyolefin | Oxygen | Elastic |
| | Layer Configuration | | | | Content Rate | Transmission | Modulus of |
| | Outermost | Intermediate | Sealant | | in Layered | Rate | Adhesive |
| | Layer | Layer | Layer | Adhesive | Body (mass %) | (cc/m²/day/atm) | (MPa) |
| Comparative | Barrier Film | Reinforcing | PP(a) | Urethane- | 91 | 4.2 | 1.5 |
| Example 1 | A | Film | | Based | | | |
| Comparative | Barrier Film | Reinforcing | PP(b) | Urethane- | 91 | 4.9 | 1.5 |
| Example 2 | A | Film | | Based | | | |
| Comparative | Barrier Film | Reinforcing | PE(c) | Urethane- | 92 | 11 | 1.5 |
| Example 3 | A | Film | | Based | | | |
| Comparative | Barrier Film | Reinforcing | PP(a) | Urethane- | 91 | 4.5 | 1.5 |
| Example 4 | B | Film | | Based | | | |
| Comparative | Reinforcing | Barrier Film | PP(a) | Urethane- | 91 | 7.9 | 1.5 |
| Example 5 | Film | A | | Based | | | |
| Comparative | Reinforcing | Barrier Film | PE(c) | Urethane- | 92 | 15 | 1.5 |
| Example 6 | Film | A | | Based | | | |
| Comparative | Reinforcing | Barrier Film | PE(c) | Urethane- | 92 | 16 | 1.5 |
| Example 7 | Film | B | | Based | | | |
| Comparative | Reinforcing | Barrier Film | PP(a) | Urethane- | 91 | 15 | 1.5 |
| Example 8 | Film | 1A | | Based | | | |

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A printed layered body for packaging having a basic layer structure comprising a barrier film, a printed layer, and an adhesive layer, the printed layered body for packaging having a polyolefin content rate adjusted to 80 mass % or more,
wherein the barrier film comprises a thermoplastic resin film (A1) and an inorganic coating (A2) formed on a surface of the thermoplastic resin film, and
the adhesive layer has a storage elastic modulus exceeding 1.5 MPa at 120° C.

2. The printed layered body for packaging according to claim 1, wherein the printed layer is provided between the inorganic coating (A2) and the adhesive layer.

3. The printed layered body for packaging according to claim 2, wherein the printed layer is formed on a surface of the inorganic coating (A2).

4. The printed layered body for packaging according to claim 3, wherein the printed layer contains titanium oxide.

5. The printed layered body for packaging according to claim 1, wherein an inner surface side film comprising a heat-sealing resin layer is laminated via the adhesive layer.

6. The printed layered body for packaging according to claim 1, wherein the adhesive layer comprises an epoxy-based adhesive.

7. The printed layered body for packaging according to claim 1, wherein the inorganic coating (A2) comprises a vapor-deposited layer deposited using the thermoplastic resin film (A1) as a base.

8. The printed layered body for packaging according to claim 7, wherein the vapor-deposited layer comprises silicon oxide, aluminum oxide, or silica-alumina composite oxide.

9. The printed layered body for packaging according to claim 7, wherein an inorganic coating layer is provided as a protective layer on the vapor-deposited layer.

10. The printed layered body for packaging according to claim 9, wherein the inorganic coating layer comprises metal alkoxide or a condensate thereof.

11. The printed layered body for packaging according to claim 5, wherein the heat-sealing resin layer comprises an olefin-based resin composition.

12. The printed layered body for packaging according to claim 11, wherein the olefin-based resin composition comprises polypropylene, linear low-density polyethylene, or a mixture of polypropylene and linear low-density polyethylene.

13. The printed layered body for packaging according to claim 11, wherein the olefin-based resin composition contains an impact polypropylene component (α), in which an ethylene-propylene copolymer is dispersed in polypropylene, and linear low-density polyethylene (β), and a mass ratio of both components (α/β) is in a range of from 99/1 to 50/50.

14. The printed layered body for packaging according to claim 1, wherein the thermoplastic resin film (A1) is a drawn polypropylene film.

15. A pouch obtained by bonding the printed layered bodies for packaging according to claim 5 by heat sealing.
